(19) United States
(12) Patent Application Publication
(10) Pub. No.: US 2025/0073985 A1
(43) Pub. Date: Mar. 6, 2025

(54) DIFFUSIOPHORESIS-ENHANCED PARTICLE DEPOSITION FOR ADDITIVE MANUFACTURING

(71) Applicant: University of Utah Research Foundation, Salt Lake City, UT (US)

(72) Inventors: Yong Lin KONG, Salt Lake City, UT (US); Samannoy GHOSH, Salt Lake City, UT (US)

(21) Appl. No.: 18/819,977

(22) Filed: Aug. 29, 2024

Related U.S. Application Data
(60) Provisional application No. 63/579,496, filed on Aug. 29, 2023.

(51) Int. Cl. B29C 64/112; B29C 64/209; B29C 64/371; B29C 64/393; B29K 25/00; B29K 105/00; B33Y 10/00; B33Y 30/00; B33Y 50/02

(52) U.S. Cl. CPC B29C 64/112; B29C 64/371; B29C 64/393; B33Y 10/00; B33Y 30/00; B33Y 50/02; B29C 64/209; B29K 2025/06; B29K 2105/251

(57) ABSTRACT

A diffusiophoresis-enhanced particle deposition system can include a deposition surface and a droplet ejector connectable to a supply of particle-containing ink, where the droplet ejector is positioned to eject droplets of the particle-containing ink onto the deposition surface. An atmosphere control chamber can surround the deposition surface. A supply of a solute gas that is soluble in the particle-containing ink can be connected to the atmosphere control chamber to provide a controlled atmospheric concentration of the solute gas to droplets on the deposition surface.

### CROSS REFERENCE TO RELATED APPLICATIONS

This application claims priority to U.S. Provisional Patent Application No. 63/579,496, filed Aug. 29, 2023, which is incorporated herein by reference.

### STATEMENT REGARDING FEDERALLY SPONSORED RESEARCH OR DEVELOPMENT

This invention was made with government support under N00014-23-1-2391, and 80NSSC20M0103 awarded by the Other Agency, R01 EB032959, and R21 EB029563 awarded by the National Institutes of Health, and 1830958 awarded by the National Science Foundation. The government has certain rights in the invention.

### NAMES OF THE PARTIES TO A JOINT RESEARCH AGREEMENT

Not applicable.

### INCORPORATION BY REFERENCE STATEMENT

Not applicable.

### BACKGROUND

The ability to control the deposition of colloids, such as nanomaterials, with a 3D printing process can impart, program, or modulate functional properties (e.g., mechanical, optical, electrical, thermal) in otherwise passive printed objects. This can be referred to as “multi-scale additive manufacturing” or AM. When integrated with extrusion-based AM, evaporative-driven assembly can leverage multi-phase interactions between solutes, solvents, substrates, and the microenvironment during the printing process. Owing to the highly sensitive nature of evaporative assembly, a broad range of multi-scale and hierarchical features (e.g., thin films to high-aspect-ratio colloidal structures) can be generated without the need of additional tools (e.g., lasers or acoustic systems), by modulating the ink and printing parameters. Indeed, the desired target patterns for AM can vary based on target application. For example, a uniform thin film may be desired when printing electronic devices (such as LEDs), but nonuniform feature, such as ring-like features, have been used to create transparent conductors.

However, the highly sensitive nature of evaporative assembly also leads to susceptibility to evaporation dynamics that lead to the creation of unintended features (i.e., defects). For example, it is challenging to consistently generate thin, uniform layers when printing active functional devices. Often, non-uniform patterns, including so-called “coffee-rings”, worm-like domains, cellular/lamellar structures, and sawtooth patterns are generated due to dynamic changes of the ink, substrate, or microenvironment.

### SUMMARY

An example diffusiophoresis-enhanced particle deposition system can include a deposition surface. A droplet ejector can be connectable to a supply of particle-containing ink. The droplet ejector can be positioned to eject droplets of the particle-containing ink onto the deposition surface. An atmosphere control chamber can surround the deposition surface. A supply of solute gas that is soluble in the particle-containing ink can be connected to the atmosphere control chamber to provide a controlled atmospheric concentration of the solute gas to droplets on the deposition surface.

An example diffusiophoresis-enhanced particle deposition method can include depositing a droplet of a particle-containing ink on a deposition surface. A controlled atmosphere can be provided surrounding the droplet. The controlled atmosphere can include a solute gas that is soluble in the particle-containing ink. The atmospheric concentration of the solute gas can be controlled in the controlled atmosphere to drive diffusiophoretic motion of particles in the droplet. The droplet can evaporate to deposit the particles on the deposition surface.

There has thus been outlined, rather broadly, features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a schematic illustration of a droplet of particle-containing ink evaporating in a carbon dioxide atmosphere, in accordance with an example of the present technology.

FIG. 1B is a schematic illustration of a droplet of particle-containing ink evaporating in a nitrogen atmosphere, in accordance with an example of the present technology.

FIG. 2 is a schematic side view of an example diffusiophoresis-enhanced particle deposition system, in accordance with an example of the present technology.

FIG. 3 is a schematic side view of another example diffusiophoresis-enhanced particle deposition system, in accordance with an example of the present technology.

FIG. 4 is a flowchart illustrating an example diffusiophoresis-enhanced particle deposition method, in accordance with an example of the present technology.

FIG. 5 is a schematic view of a diffusiophoresis-enhanced particle deposition system used in the experimental examples, in accordance with an example of the present technology.

FIGS. 6A-6C show simulated flow profiles of droplets of particle-containing ink.

FIGS. 7A-7C show simulated droplets of particle-containing ink at different evaporation times.

FIG. 8 is a graph of ion concentration over radial distance in a simulated droplet of particle-containing ink.

FIG. 9 is a graph of diffusiophoretic velocity of particles in the simulated droplet of particle-containing ink.

FIG. 10 is a graph of relative fluid velocity magnitude with and without Marangoni effects of a simulated droplet of particle-containing ink.

FIG. 11 shows fluorescent images of particle patterns of dried droplets of particle-containing ink.

FIG. 12 illustrates an image processing workflow used to calculate droplet size.

FIG. 13 shows fluorescent images of particles in evaporating droplets of particle-containing ink.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a particle” includes reference to one or more of such materials and reference to “the droplet” refers to one or more of such droplets.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Example Embodiments

The present disclosure describes systems and methods that can be used for depositing particles in evaporation-driven additive manufacturing. As explained above, it can be difficult to deposit materials uniformly in evaporative-driven AM because of the evaporation dynamics of droplets of ink. Some control can be achieved by modulating multi-phase dynamics and soft matter physics. For example, Marangoni effects can be introduced via the addition of co-solvents, thermal gradients, or vapor concentrations. These can induce recirculating flows that drive colloids away from a contact line toward the drop center. In previous work, quantum dot (QD) solutions with a dichlorobenzene co-solvent produced microstructures with greater uniformity than those with pure toluene. Undesirable “coffee-ring” effects can be reduced by treating silicon and polydimethylsiloxane substrates with plasma to depin the contact line. Mechanical templates can also guide assembly or introduce confinement to modulate drying behaviors. However, these strategies introduce interfering parameters, such as changes in solution composition that can alter the properties of the printed film or utilize additional templates and devices that limit potential applications and scalability for manufacturing practice. Therefore, the systems and methods described herein do not rely on additional solvents, vapors, thermal gradients, or mechanical templates.

The systems and methods described herein can be used to deposit particles with a high degree of control by utilizing diffusiophoresis to control particles in an ink. Diffusiophoresis is the spontaneous phoretic motion of colloidal particles due to local solute concentration gradients. In some examples, an ink that includes colloidal particles can be printed on a deposition surface and diffusiophoresis can be used to control the assembly and deposition of the particles on the substrate when the ink evaporates. Diffusiophoresis can play a dominant role in the complex process of evaporative-driven particle assembly, enabling a versatile control of particle deposition in multi-scale AM processes. The systems and methods described herein can utilize diffusiophoresis without adding extra solvents, contaminating solutes, or mechanical templates.

Diffusiophoresis can include chemiphoretic and electrophoretic contributions. Chemiphoresis is the motion of a particle due to an osmotic pressure gradient along the particle's surface, and electrophoresis occurs with electrolyte solutes when the cations and anions have different diffusivities. In an electrolyte gradient, this difference leads to the spontaneous generation of a local electric field. As the counter ions are attracted to the surface, a thin layer of charged fluid called the Debye layer forms around the particle. This layer is accelerated by the electric field, resulting in spontaneous particle motion.

Chemiphoresis drives particles up the solute gradient, and electrophoresis may act in either direction. Another phenomenon, diffusioosmosis, occurs where solute gradients induce slip over solid surfaces, and this extends to particle diffusiophoresis in electrolyte gradients. It has been shown that in a solute concentration gradient ∇c, the diffusiophoretic velocity of a particle is u_{dp}=Γₚ∇lnc, where Γₚ is the diffusiophoretic mobility, a function of the particle's size and zeta potential. This logarithmic dependence is the source of several particle behaviors facilitating control strategies such as banding/focusing and long-lived chemically driven effects. Furthermore, diffusiophoresis can cause a variety of effects on particle behaviors, including banding, focusing, patterning, tuning of colloidal interactions, and enhanced particle transport.

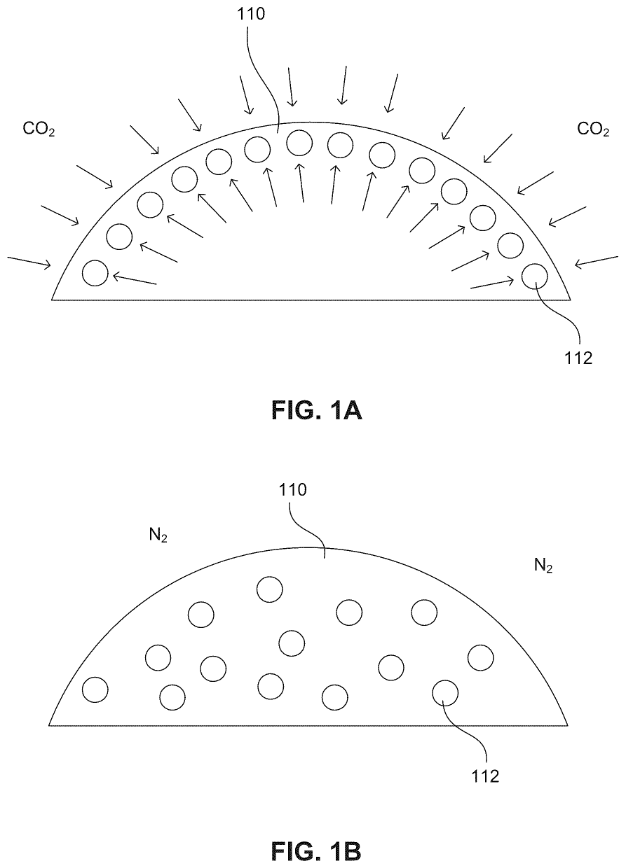

The systems and methods described herein can utilize a non-contaminating solute gas to drive diffusiophoresis of particles in ink. As an example, carbon dioxide can be used as a solute gas with an aqueous ink. Carbon dioxide has good solubility in water, and can also react with water to form carbonic acid, which dissociates to form cations and carbonate anions in the water. In certain examples, the aqueous ink can include positively charged particles. Chemiphoresis and electrophoresis effects can both operate on the positively charged particles when carbon dioxide dissolved into the ink. FIG. 1A shows an example of a droplet of aqueous ink 110 deposited on a deposition surface, where the ink includes positively charged particles 112. A carbon dioxide atmosphere is present surrounding the droplet. In this example, the particles in the droplet move outward toward the surface of the droplet while carbon dioxide dissolves into the droplet. FIG. 1B shows a comparative example in which the atmosphere outside the droplet is nitrogen. Because nitrogen has a lower solubility than carbon dioxide, nitrogen does not dissociate to generate ions that can cause this diffusiophoretic effect. Therefore, the particles are organized more randomly in the droplet. This is a single example, but other combinations of inks and solute gases can also be used to provide control over the deposition of particles through diffusiophoresis.

In some examples, a diffusiophoresis-enhanced particle deposition system can include a deposition surface with an atmosphere control chamber surrounding the deposition surface. A droplet ejector can be used to eject droplets of particle-containing ink onto the deposition surface, and the atmosphere control chamber can be used to control the atmosphere surrounding the droplets. The system can include a supply of a solute gas that is soluble in the particle-containing ink. The supply of solute gas can be connected to the atmosphere control chamber to provide a controlled concentration of the solute gas in the atmosphere control chamber.

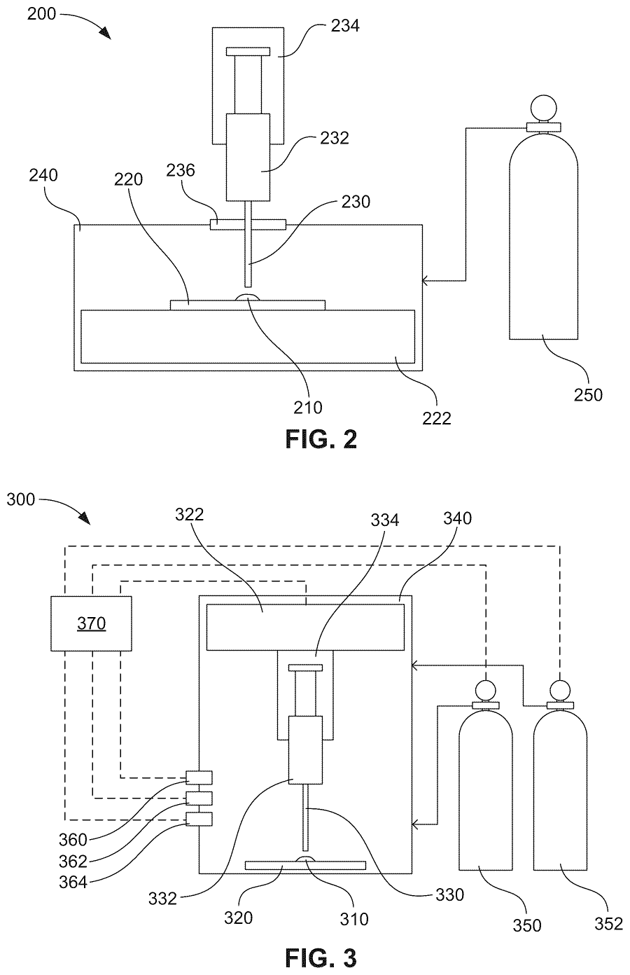

FIG. 2 shows a schematic side view of an example diffusiophoresis-enhanced particle deposition system 200. This system includes a particle deposition surface 220. A droplet ejector 230 is positioned above the deposition surface so that the droplet ejector can eject droplets 210 of a particle-containing ink onto the deposition surface. The droplet ejector is connected to a particle-containing ink supply 232. In this example, the droplet ejector is a needle and the ink supply is a syringe reservoir connected to the needle. A syringe pump 234 is used to eject controlled amounts of the particle-containing ink to form droplets on the deposition surface. The deposition surface is held by a motion platform 222. The motion platform can move the deposition surface relative to the position of the needle, so that droplets of ink can be ejected onto different locations on the deposition surface. In various examples, the motion platform can be capable of moving the deposition surface in one, two, or three dimensions (i.e., along an x-axis, y-axis, and/or z-axis). The system also includes an atmosphere control chamber 240 surrounding the deposition surface. This atmosphere control chamber is configured to maintain a controlled atmosphere around the droplets as the droplets evaporate. A solute gas supply 250 is connected to the atmosphere control chamber. The solute gas supply can contain a solute gas that is soluble in the particle-containing ink. The solute gas can be introduced into the atmosphere control chamber to provide a controlled atmospheric concentration of the solute gas to the droplets on the deposition surface. This system also includes a septum 236 that allows the needle to enter the atmosphere control chamber. The septum prevents air from outside the chamber from entering and also prevents the gas inside the chamber from leaking out around the needle.

The atmosphere control chamber can be used to provide a controlled atmospheric concentration of the solute gas surrounding droplets of particle-containing ink on the deposition surface while the droplets evaporate. In some examples, the atmosphere control chamber can be sealed and airtight to ensure that the atmosphere within is fully controlled. In other examples, the atmosphere control chamber can have outlets, vents, or other openings such that the chamber is not fully sealed. In some examples, a humidifier or dehumidifier can be incorporated to regulate relative humidity levels inside the chamber. Additionally, heating and cooling systems can be implemented to regulate temperature inside the chamber. In certain examples, a positive pressure can be maintained within the atmosphere control chamber. The positive pressure can be maintained by pumping the solute gas into the chamber, optionally together with one or more diluent gases. The positive pressure can prevent air from entering into the atmosphere control chamber. Therefore, the concentration of the solute gas can be controlled in the atmosphere control chamber.

Any design and shape can be used for the atmosphere control chamber as long as the chamber allows a controlled concentration of the solute gas to be provided surrounding the droplets on the deposition surface. As a general guideline, the atmosphere control chamber can provide a positive pressure such that ingress of external environment can be reduced or avoided. In some cases, the atmosphere control chamber can provide a sealed enclosure capable of maintaining pressures up to 2 atm, in some cases up to 5 atm.

In some examples, the deposition surface can be enclosed by the atmosphere control chamber. In further examples, the deposition surface and a print volume on the deposition surface can both be enclosed by the atmosphere control chamber. In certain examples, the atmosphere control chamber can include a septum and the droplet ejector can include a needle that pierces the septum to enter the atmosphere control chamber and deposit droplets of ink on the deposition surface. In further examples, the droplet ejector can be permanently integrated as a part of the atmosphere control chamber. In other examples, the droplet ejector can be enclosed within the atmosphere control chamber. For example, the atmosphere control chamber can be large enough that the entire droplet ejector can be inside the atmosphere control chamber. In some such examples, the droplet ejector can be connected to an external supply of particle-containing ink that is outside the atmosphere control chamber. In other examples, the supply of ink can also be enclosed within the atmosphere control chamber. In certain examples, the droplet ejector and/or ink supply can be parts of a 3D printer that is enclosed inside the atmosphere control chamber.

The supply of solute gas can be connected to the atmosphere control chamber to provide the controlled atmospheric concentration of the solute gas inside the atmosphere control chamber. In certain examples, the solute gas supply can be outside the atmosphere control chamber, and connected to the chamber by tubing, pipe, or another conduit that can carry the solute gas into the chamber. In other examples, the supply of solute gas can be enclosed inside the atmosphere control chamber. In this case, the solute gas supply can be configured to release the solute gas from the supply out into the atmosphere control chamber.

The deposition surface and/or the droplet ejector can be operatively connected to a motion platform that can move the droplet ejector with respect to the deposition surface. This can allow the droplet ejector to deposit droplets of ink in multiple different locations on the deposition surface. In some examples, the motion platform can provide motion along 1 axis, 2 axes, 3 axes, 4 axes, 5 axes, or 6 axes, where the axes can be translational or rotational axes. The deposition surface can remain stationary while the motion platform moves the droplet ejector. Alternatively, the droplet ejector can remain stationary while the motion platform moves the droplet ejector. In still other examples, the motion platform can move the deposition surface and the droplet ejector. In certain examples, the deposition surface can move along one axis, such as the y-axis, while the droplet ejector can move along two axes, such as the x-axis and z-axis. The deposition surface and the droplet ejector can have any other combination of movement axes, which can allow the droplet ejector to move in relation to the deposition surface. In certain examples, the droplet ejector can rotate about at least one rotational axis. In particular examples, the droplet ejector can rotate about exactly one rotational axis, or about exactly two rotational axes, or about exactly three rotational axes. This can allow the droplet ejector to eject ink at various angles instead of being limited to ejecting ink straight down onto the deposition surface.

The motion platform can be configured to move the droplet ejector relative to the deposition surface by small distance increments, which can allow printing in high resolution. In some examples, the motion platform and the droplet ejector can be capable of printing the particle-containing ink with a resolution from 1 micrometer to 1 millimeter, or from 1 micrometer to 500 micrometers, or from 1 micrometer to 300 micrometers, or from 1 micrometer to 200 micrometers, or from 1 micrometer to 100 micrometers, or from 1 micrometer to 50 micrometers, or from 1 micrometer to 10 micrometers, or from 10 micrometers to 1 millimeter, or from 10 micrometers to 500 micrometers, or from 10 micrometers to 300 micrometers, or from 10 micrometers to 200 micrometers, or from 10 micrometers to 100 micrometers, or from 10 micrometers to 50 micrometers, or from 50 micrometers to 1 millimeter, or from 50 micrometers to 500 micrometers, or from 50 micrometers to 300 micrometers, or from 50 micrometers to 200 micrometers, or from 50 micrometers to 100 micrometers, or from 100 micrometers to 1 millimeter, or from 100 micrometers to 500 micrometers, or from 100 micrometers to 300 micrometers, or from 100 micrometers to 200 micrometers, or from 200 micrometers to 1 millimeter, or from 200 micrometers to 500 micrometers, or from 200 micrometers to 300 micrometers, or from 300 micrometers to 1 millimeter, or from 300 micrometers to 500 micrometers, or from 500 micrometers to 1 millimeter. The ejector can also be performed with inkjet printheads (continuous or drop on demand) or any other mechanisms which can create droplets with submicrometer resolution (ranging from picoliters to tens of picoliters). Non-limiting examples of suitable ejection deposition mechanisms can include inkjet, aerosol jet, electrohydrodynamic jet, printed droplet microfluids, drop impact printing, and the like. These resolutions can refer to the printed resolution in one or two horizontal axes, i.e., the x-axis and/or the y-axis. These horizontal axes can be the horizontal directions across the deposition surface.

In further examples, the vertical resolution, or z-axis resolution, can also be referred to as the layer thickness. The layer thickness can depend on the movement of the droplet ejector relative to the deposition surface in the vertical z-axis direction, as well as on the size of particles and concentration of particles in the particle-containing ink. In some examples, droplets of the particle-containing ink can evaporate and deposit a layer of particles that is a single particle thick. In such examples, the layer thickness can be the same as the size of the particles. In other examples, the concentration of particles in the particle-containing ink can be sufficient that the layer of particles deposited by an evaporating droplet is multiple particles thick. In various examples, the layer thickness can be from about 10 nanometers to about 1 millimeter, or from about 10 nanometers to about 100 micrometers, or from about 10 nanometers to about 10 micrometers, or from about 10 nanometers to about 1 micrometer, or from about 10 nanometers to about 100 nanometers, or from about 100 nanometers to about 1 millimeter, or from about 100 nanometers to about 100 micrometers, or from about 100 nanometers to about 10 micrometers, or from about 100 nanometers to about 1 micrometer, or from about 1 micrometer to about 1 millimeter, or from about 1 micrometer to about 100 micrometers, or from about 1 micrometer to about 10 micrometers, or from about 10 micrometers to about 1 millimeter, or from about 10 micrometers to about 100 micrometers, or from about 100 micrometers to about 1 millimeter.

The motion platform can also allow rotational movement of the droplet ejector with respect to the deposition surface in some examples. The rotation can be about one axis, or two axes, or three axes in some cases. For each rotational axis, the motion platform can provide an amount of rotation from about 0° to about 360°, or from about 0° to about 180°, or from about 0° to about 90°, or from about 0° to about 60°, or from about 0° to about 45°, or from about 0° to about 30°, or from about 300 to about 360°, or from about 300 to about 180°, or from about 300 to about 90°, or from about 300 to about 60°, or from about 300 to about 45°, or from about 450 to about 360°, or from about 450 to about 180°, or from about 450 to about 90°, or from about 450 to about 60°, or from about 600 to about 360°, or from about 600 to about 180°, or from about 600 to about 90°, or from about 900 to about 360°, or from about 900 to about 180°, or from about 1800 to about 360°.

The diffusiophoresis-enhanced particle deposition system can also include a controller. The controller can be operatively connected to the supply of solute gas to control a flow of the solute gas to the atmosphere control chamber. In some examples, the controller can be programmed with coded instructions to adjust the flow of the solute gas to provide the controlled atmospheric concentration of the solute gas to the droplets on the deposition surface. In particular, the controller can include a processor that can execute such coded instructions. The coded instructions can be stored in a computer-readable storage medium, such as any type of memory.

The controller can be configured to other aspects and components of the system, in addition to adjusting the flow of solute gas into the atmosphere control chamber. In some examples, the system can include a supply of diluent gas and the controller can be configured to adjust a flow rate of diluent gas into the atmosphere control chamber. The concentration of the solute gas in the atmosphere control chamber can be precisely controlled by adjusting the flow rates of the solute gas and the diluent gas. The system can also include sensors that can measure various conditions in the atmosphere control chamber. In some examples, these sensors can also be connected to the controller to provide condition data. The controller can be programmed to adjust the flow of solute gas and/or diluent gas into the atmosphere control chamber based on data from the sensors. As an example, the system can include a gas sensor that can measure the concentration of the solute gas in the atmosphere control chamber. The gas sensor can be connected to the controller and the controller can automatically adjust the flow rate of solute gas into the atmosphere control chamber to achieve a desired concentration. Other types of sensors that can be included in the system can include gas composition sensors, temperature sensors, humidity sensors, microscopic cameras, fluorescence sensors, and others. Any of these sensors can be connected to the controller to provide data about conditions in the atmosphere control chamber. The controller can also be connected to other components of the system that can influence these conditions, such as a heater, a cooler, a humidifier, a dehumidifier, a light source, and others.

In some examples, the controller can also be configured to control the motion of the motion platform and/or to control the ejection of ink from the droplet ejector. Thus, a single controller can control the entire system in some examples. The controller can include one or more modules configured to control different aspects or components of the system. In one example, the controller can include a printing module that controls the motion platform and the droplet ejector. The controller can also include an atmosphere control module that can control the atmospheric concentration of the solute gas. The atmosphere control module can also receive data from a gas composition sensor. Other modules can also be included, such as a temperature control module, an imaging module, a communication module, a user interface module, or other modules.

FIG. 3 shows a schematic view of another example diffusiophoresis-enhanced particle deposition system 300. This system includes a deposition surface 320 and a droplet ejector 330 positioned to ejected droplets 310 of particle-containing ink. In this example, the droplet ejector is a syringe needle connected to a particle-containing ink supply 332, which in this example is a syringe reservoir filled with the particle-containing ink. The system also includes a syringe pump 334 that can eject controlled amounts of the particle-containing ink out through the needle to form droplets. The syringe pump and syringe are connected to a motion platform 322 that can move the syringe while the deposition surface remains stationary. In this example, the system includes an atmosphere control chamber 340 that encloses the entire deposition surface, droplet ejector, and motion platform. A solute gas supply 350 and a diluent gas supply 352 are connected to the atmosphere control chamber. Several sensors, including a gas composition sensor 360, a temperature sensor 362, and a humidity sensor 364, are positioned to measure conditions in the atmosphere control chamber. The sensors are connected to a controller 370 to provide data about the conditions to the controller. The controller is also connected to the motion platform, the syringe pump, the solute gas supply, and the diluent gas supply. The connections can be wired connections or wireless connections. The controller can include a processor and modules as explained above. In some examples, the controller can be a personal computer, a microcontroller integrated into the system, a computer connected over a wired or wireless network, a tablet computer, a smartphone, or another type of controller.

The solute gas can be a gas that is soluble in the particle-containing ink. In some examples, the solute gas can comprise carbon dioxide. Carbon dioxide is soluble in water. Therefore, carbon dioxide can be used as the solute gas with aqueous inks in some examples. Carbon dioxide can also dissolve in other solvents. In some examples, the solute gas can be ammonia, that dissolves in water. The solute gases dissolve in water and dissociate to form ions that can drive diffusiophoretic flow of the particles. In some examples, the particle-containing ink can include any solvent or combination of solvents in which carbon dioxide is soluble and can dissociate into ions. In certain examples, the particle-containing ink can include water, ethanol, other alcohols, polar hydrocarbon solvents, acetone, methyl ethyl ketone, or other solvents in which carbon dioxide is soluble and dissociate into ions that drive diffusiophoresis.

In some examples, the solubility of the solute gas in the particle-containing ink can be 50 mg/L or greater at 20° C. and 1 atm pressure. In other examples, the solubility of the solute gas can be 100 mg/L or greater, or 150 mg/L or greater, or 200 mg/L or greater at 20° C. and 1 atm pressure. In certain examples, the solubility of the solute gas can be in a range from 50 mg/L to 5 g/L, or from 50 mg/L to 1 g/L, or from 50 mg/L to 500 mg/L, or from 50 mg/L to 300 mg/L, or from 50 mg/L to 200 mg/L, or from 50 mg/L to 150 mg/L, or from 50 mg/L to 100 mg/L, or from 100 mg/L to 5 g/L, or from 100 mg/L to 1 g/L, or from 100 mg/L to 500 mg/L, or from 100 mg/L to 300 mg/L, or from 100 mg/L to 200 mg/L, or from 100 mg/L to 150 mg/L, or from 150 mg/L to 5 g/L, or from 150 mg/L to 1 g/L, or from 150 mg/L to 500 mg/L, or from 150 mg/L to 300 mg/L, or from 150 mg/L to 200 mg/L, or from 200 mg/L to 5 g/L, or from 200 mg/L to 1 g/L, or from 200 mg/L to 500 mg/L, or from 200 mg/L to 300 mg/L, or from 300 mg/L to 5 g/L, or from 300 mg/L to 1 g/L, or from 300 mg/L to 500 mg/L, or from 500 mg/L to 5 g/L, or from 500 mg/L to 1 g/L, or from 1 g/L to 5 g/L.

In the solution, the solute gas forms ions when dissolved in the particle-containing ink, that can drive diffusiophoresis. For example, when carbon dioxide dissolves in an aqueous particle-containing ink, the carbon dioxide can form cations, carbonate anions, and bicarbonate anions. In some examples, when ammonia dissolves in an aqueous particle-containing ink, the gas reacts to form ammonium cations and hydroxyl anions. In other examples, when sulphur trioxide dissolves in aqueous particle-containing ink, the gas reacts to form cations and sulphate anions.

The solute gas can drive diffusiophoretic effects as the gas dissolves into droplets of the particle-containing ink. The concentration of the solute gas outside the droplets can be higher than the initial concentration of the solute gas in the ink. In some examples, the particle-containing ink can initially be devoid of the solute gas or can have a low concentration of the solute gas relative to the concentration of the solute gas in the atmosphere control chamber.

A diluent gas can be used together with the solute gas in some examples. The diluent gas can have a low solubility in the particle-containing ink relative to the solute gas. It is noted that the diluent gas may have a slight solubility in the particle-containing ink, but the solubility of the diluent gas can be sufficiently low in comparison to the solute gas that the diluent gas has little effect on diffusiophoretic movement of particles in the ink. In certain examples, the diluent gas can have a solubility in the particle-containing ink that is less than 100 mg/L, or less than 50 mg/L, or less than 30 mg/L, or less than 20 mg/L at 20° C. and 1 atm pressure. Furthermore, in some examples the particle-containing ink can have an initial concentration of the diluent gas that is saturated. Alternatively, the particle-containing ink can have an initial concentration of the diluent gas that balances with the concentration of the diluent gas in the atmosphere control chamber so that there is no net diffusion of the diluent gas into the droplet of ink inside the atmosphere control chamber.

In some examples, the diluent gas can comprise air, nitrogen, argon, helium, oxygen, hydrogen, or another gas with a lower solubility compared to the solute gas. In certain examples, the diluent can comprise air taken from the atmosphere surrounding the atmosphere control chamber. In other examples, the diluent gas can be supplied by a gas tank or gas generator, such as a tank of nitrogen gas or an oxygen generator.

The relative flow rate of the diluent gas and the solute gas into the atmosphere control chamber can be adjusted to change the concentration of solute gas in the atmosphere control chamber. In various examples, the concentration of solute gas in the atmosphere control chamber can be from about 1 vol % to about 100 vol %, or from about 1 vol % to about 80 vol %, or from about 1 vol % to about 60 vol %, or from about 1 vol % to about 40 vol %, or from about 1 vol % to about 20 vol %, or from about 20 vol % to about 100 vol %, or from about 20 vol % to about 80 vol %, or from about 20 vol % to about 60 vol %, or from about 20 vol % to about 40 vol %, or from about 40 vol % to about 100 vol %, or from about 40 vol % to about 80 vol %, or from about 40 vol % to about 60 vol %, or from about 60 vol % to about 100 vol %, or from about 60 vol % to about 80 vol %, or from about 80 vol % to about 100 vol %.

The solute gas and diluent gas, if used, can flow into the atmosphere control chamber with a total space velocity of the solute gas and diluent gas combined, where the space velocity is defined as the total flow rate of the gases into the atmosphere control chamber divided by the volume of the atmosphere control chamber. The atmosphere control chamber can also include one or more outlets that allow gas to flow out of the chamber at about the same rate as gas flows in, which prevents pressure buildup in the atmosphere control chamber. In some examples, the total space velocity of the solute gas and the diluent gas flowing into the atmosphere control chamber can be from 1 h⁻¹ to 10 min⁻¹, or from 1 h⁻¹ to 1 min⁻¹, or from 1 h⁻¹ to 10 h⁻¹, or from 1 h⁻¹ to 5 h⁻¹, or from 1 h⁻¹ to 2 h⁻¹, or from 2 h⁻¹ to 10 min⁻¹, or from 2 h⁻¹ to 1 min⁻¹, or from 2 h⁻¹ to 10 h⁻¹, or from 2 h⁻¹ to 5 h⁻¹, or from 5 h⁻¹ to 10 min⁻¹, or from 5 h⁻¹ to 1 min⁻¹, or from 5 h⁻¹ to 10 h⁻¹, or from 10 h⁻¹ to 10 min⁻¹, or from 10 h⁻¹ to 1 min⁻¹, or from 1 min⁻¹ to 10 min⁻¹.

The concentration of the solute gas can be controlled in the atmosphere control chamber in order to drive diffusiophoretic motion of particles in droplets of ink on the deposition surface. In some examples, when the solute gas dissolves into the droplets, diffusiophoresis can drive the particles in the droplets to move toward the boundary between the liquid droplets and the gas in the atmosphere control chamber. This motion can spread the particles out throughout the volume of the droplet and cause the particles to be deposited in a more even and predictable pattern than would occur without diffusiophoresis. In further examples, the motion of the particles toward the boundary of the droplet can also help the droplet maintain its shape while drying. Droplets can typically have a circular footprint when first deposited on the deposition surface. However, without the diffusiophoretic effects, droplets can tend to shrink while drying. The shrinking droplets de-wet portions of the surface in the original droplet footprint, but this de-wetting can be random and difficult to predict, which can result in an irregularly shaped smaller droplet. The particles in the ink can be randomly distributed throughout this smaller irregularly shaped droplet, which causes the particles to ultimately be deposited in an irregular and unpredictable manner. In contrast, when diffusiophoretic motion cause the particles to move toward the boundary of the droplet, the particles are spread much more evenly and predictably. The outward motion of the particles also has the effect of maintaining the original footprint of the droplet. Instead of de-wetting the surface and shrinking to an irregularly shaped droplet, the droplet maintains its circular shape as the liquid ink dries. When the solvent in the ink finally evaporates, the particles can be deposited on the deposition surface in a more regular and predictable pattern.

Evaporation in air is driven by the difference between the saturated concentration at the air/liquid interface and the ambient value in the environment. For contact angles smaller than 90°, evaporative flux is highest at the droplet edge so that the dominant flow in the absence of temperature gradients is radially outward. Evaporation typically drives non-uniform cooling that generates recirculating Marangoni flows via surface tension gradients. For a pinned droplet of radius R with small contact angle θ in an axisymmetric system of coordinates r and z, the local height h is:

$$h ( r , t ) = \frac{{R}^{2} - {r}^{2}}{2 R} θ ( t ) . \qquad ( 1 )$$

The evaporation flux J for a quasi-steady, diffusion-dominated process is:

$$J ( r ) = \frac{2}{π} \frac{{D}_{vap} Δ c}{\sqrt{{R}^{2} - {r}^{2}}} , \qquad ( 2 )$$

where Dᵥₐₚ is the diffusion coefficient for water vapor in air (=26×10⁻⁶ m² s⁻¹ at 25° C.) and Δc is the water vapor concentration difference (=1.6×10⁻² kg m⁻³ at a relative humidity of 30%) between the drop surface and the surrounding. The contact angle θ can be expressed as a function of time t as:

$$θ ( t ) = \frac{16 {D}_{vap} Δ c}{π {R}^{2} ρ} ( {t}_{e} - t ) , \qquad ( 3 )$$

where tₑ is the total evaporation time and ρ is the density.

When a sessile water droplet is exposed to CO₂, some CO₂ dissolves and produces ions inside the drop by the equilibrium chemical reaction (CO₂+H₂O↔H⁺+HCO₃₋). For a stationary, non-evaporating drop, the CO₂ and ion concentrations, c_{c} and cᵢ, are respectively governed by coupled diffusion-reaction equations given by

$$\frac{\partial {c}_{c}}{\partial t} = ∇ \cdot ( {D}_{c} ∇ {c}_{c} ) - ( {k}_{f} {c}_{c} - {k}_{b} {c}_{i}^{2} ) , \qquad ( 4 a )$$

$$\frac{\partial {c}_{i}}{\partial t} = ∇ \cdot ( {D}_{i} ∇ {c}_{i} ) + ( {k}_{f} {c}_{c} - {k}_{b} {c}_{i}^{2} ) , \qquad ( 4 b )$$

where D_{c} is the diffusivity of CO₂ in water (=1.9×10⁻⁹ m² s⁻¹) and Dᵢ is the ambipolar diffusion coefficient of the ions (Dᵢ=2D₊D₋/(D₊+D₋)=2.1×10⁻⁹ m² s⁻¹) where D₊=9.311×10⁻⁹ m² s⁻¹ and DD₋=1.185×10⁻⁹ m² s⁻¹ are the cation and anion diffusivities, respectively. The reaction rates for the forward and backward reactions are k_{f}=0.039 s⁻¹ and k_{b}=9.2 M⁻¹ s⁻¹, respectively. At the gas/liquid interface, the saturated CO₂ concentration is c_{c,s}=p_{CO2}/Kh=0.034 M where p_{CO2} is the partial pressure of CO₂ (=1 atm) and Kₕ is the Henry's law constant of CO₂ (=29.4 atm/M). The saturated ion concentration c_{i,s} can be calculated as c_{i,s}=1.2×10⁻⁴ M with the assumption of local chemical equilibrium (k_{f}c_{c,s}−k_{b}c_{i,s}²=0). Initial CO₂ and ion concentrations in the droplet are calculated at p_{CO2}=4×10⁻⁴ atm, and are c_{c,i}=1.3×10^{-s} M and c_{i,i}=2.4×10⁻⁶ M, respectively. Ion concentration gradients drive particle motion via diffusiophoresis at a velocity u_{dp} of:

$${u}_{dp} = {Γ}_{p} ∇ ln {c}_{i} , \qquad ( 5 )$$

where Γₚ is the diffusiophoretic mobility. Finite Debye layer effects are considered because the Debye layer thickness to particle radius ratio λ=(κa)⁻¹, where κ⁻¹=\sqrt{εk_{B}T/2Z²e²c}. As an example, the particles in the ink can be polystyrene particles with a diameter of 1 micrometer. For these particles, κ⁻¹ is approximately 0.078 at c=(c_{i,i}+c_{i,s})/2≈0.06 mM. Thus, diffusiophoretic mobilities are calculated as:

$${Γ}_{p} = \frac{ε}{μ} {( \frac{{k}_{B} T}{Ze} )}^{2} \{ \frac{Ze ζβ}{{k}_{B} T} g ( λ ) + 4 ln [ cosh ( \frac{Z e ζ}{4 {k}_{B} T} ) ] h ( λ ) \} , \qquad ( 6 a )$$

$$g ( λ ) = {\{ 1 - \frac{λ {k}_{B} T}{2 Ze ζ} [ {F}_{1} + \frac{ε}{2 μ {D}_{s}} {( \frac{{k}_{B} T}{Ze} )}^{2} ( β {F}_{4} + {F}_{5} ) ] \}}^{- 1} , \qquad ( 6 b )$$

$$h ( λ ) = {\{ 1 - \frac{λ}{8 ln cosh ( \frac{Ze ζ}{4 {k}_{B} T} )} [ {F}_{0} + \frac{ε}{2 μ {D}_{s}} {( \frac{{k}_{B} T}{Ze} )}^{2} ( {F}_{2} + β {F}_{3} ) ] \}}^{- 1} , \qquad ( 6 c )$$

where ε is the permittivity, μ is the dynamic viscosity, k_{B} is the Boltzmann constant, T is the temperature, Z is the ion valence (z₊=−z₋=1), e is the elementary charge, ζ is the zeta potential, and β is (D₊−D₋)/(D₊+D₋) for a Z:Z electrolyte. The Fₙ functions depend on ζ and are calculated using curve fits based on values from. The mean ζ can be measured at c=c_{i,s} and c=c_{i,i}, where ζ=(42+20)/2=31 mV, which corresponds to Γp≈0.3×10⁻⁹ m⁻² s⁻¹ for aPS particles.

The values calculated above assume that the example particles are polystyrene particles with a diameter of 1 micrometer. In other examples, a variety of different particles can be included in the particle-containing ink. The particle size of the particles can vary, and in some examples can be from 10 nanometers to 100 micrometers, or from 10 nanometers to 10 micrometers, or from 10 nanometers to 1 micrometer, or from 10 nanometers to 100 nanometers, or from 100 nanometers to 100 micrometers, or from 100 nanometers to 10 micrometers, or from 100 nanometers to 1 micrometer, or from 1 micrometer to 100 micrometers, or from 1 micrometer to 10 micrometers, or from 10 micrometers to 100 micrometers.

The particles can also be made from different materials. In some examples, the particles can comprise polymer microparticles, polymer nanoparticles, quantum dots, cells, metal microparticles, surface functionalized particles, or combinations thereof. Non-limiting examples of polymer microparticles can include polystyrene microspheres. Non-limiting examples of quantum dots can comprise elements including metals such as gold, silver, cadmium, mercury, selenium, tellurium, indium, zinc, lead, phosphorus, or other metals, as well as carbon, sulfides, arsenides, and other materials. Non-limiting examples of metal microparticles can include gold, silver, copper, iron and other materials.

In some examples, the particles can have an electric charge. In certain examples, the particles can have surface functionalization such as amine, carboxyl or sulphate. In some examples, the particles can have a positive charge or a negative charge and this surface charge or zeta potential of the particles, can significantly affect the flow dynamics in the droplet.

The concentration of the particles in the ink can be from about 1 mg/mL to about 50 mg/mL in some examples. In further examples, the concentration of particles can be from about 1 mg/mL to about 30 mg/mL, or from about 1 mg/mL to about 20 mg/mL, or from about 1 mg/mL to about 15 mg/mL, or from about 1 mg/mL to about 10 mg/mL, or from about 1 mg/mL to about 5 mg/mL, or from about 5 mg/mL to about 50 mg/mL, or from about 5 mg/mL to about 30 mg/mL, or from about 5 mg/mL to about 20 mg/mL, or from about 5 mg/mL to about 15 mg/mL, or from about 5 mg/mL to about 10 mg/mL, or from about 10 mg/mL to about 50 mg/mL, or from about 10 mg/mL to about 30 mg/mL, or from about 10 mg/mL to about 20 mg/mL, or from about 10 mg/mL to about 15 mg/mL, or from about 15 mg/mL to about 50 mg/mL, or from about 15 mg/mL to about 30 mg/mL, or from about 15 mg/mL to about 20 mg/mL, or from about 20 mg/mL to about 50 mg/mL, or from about 20 mg/mL to about 30 mg/mL, or from about 30 mg/mL to about 50 mg/mL. In certain examples, the particles can have a concentration such that the layer of particles deposited when a droplet evaporates is a single particle thick or less on average.

The particle-containing ink can have a viscosity about equal to the viscosity of water in some examples. In further examples, the particle-containing ink can have a viscosity at 20° C. from about 0.5 centipoise to about 50 centipoise, or from about 0.5 centipoise to about 20 centipoise, or from about 0.5 centipoise to about 10 centipoise, or from about 0.5 centipoise to about 5 centipoise, or from about 0.5 centipoise to about 2 centipoise, or from about 0.5 centipoise to about 1 centipoise, or from about 1 centipoise to about 50 centipoise, or from about 1 centipoise to about 20 centipoise, or from about 1 centipoise to about 10 centipoise, or from about 1 centipoise to about 5 centipoise, or from about 1 centipoise to about 2 centipoise, or from about 2 centipoise to about 50 centipoise, or from about 2 centipoise to about 20 centipoise, or from about 2 centipoise to about 10 centipoise, or from about 2 centipoise to about 5 centipoise, or from about 5 centipoise to about 50 centipoise, or from about 5 centipoise to about 20 centipoise, or from about 5 centipoise to about 10 centipoise, or from about 10 centipoise to about 50 centipoise, or from about 10 centipoise to about 20 centipoise, or from about 20 centipoise to about 50 centipoise.

The particle-containing ink can also have a surface tension similar to water in some examples. In various examples, the particle-containing ink can have a surface tension at 20° C. from about 10 mN/m to about 100 mN/m, or from about 10 mN/m to about 75 mN/m, or from about 10 mN/m to about 60 mN/m, or from about 10 mN/m to about 40 mN/m, or from about 10 mN/m to about 20 mN/m, or from about 20 mN/m to about 100 mN/m, or from about 20 mN/m to about 75 mN/m, or from about 20 mN/m to about 60 mN/m, or from about 20 mN/m to about 40 mN/m, or from about 40 mN/m to about 100 mN/m, or from about 40 mN/m to about 75 mN/m, or from about 40 mN/m to about 60 mN/m, or from about 60 mN/m to about 100 mN/m, or from about 60 mN/m to about 75 mN/m, or from about 75 mN/m to about 100 mN/m.

In some examples, the particle-containing ink can consist of a solvent and the solid particles that are to be deposited when the solvent evaporates. In further examples, the particle-containing ink can consist essentially of the solvent and the solid particles. In certain examples, the particle-containing ink can be free of binders or substantially free of binders. In further examples, the particle-containing ink can be free of colorants or substantially free of colorants. In still further examples, the particle-containing ink can be free of gels or substantially free of gels.

The present disclosure also describes diffusiophoresis-enhanced particle deposition methods. In some examples, these methods can be additive manufacturing methods that allow particles from a particle-containing ink to be deposited in any desired pattern on a deposition surface to make two-dimensional or three-dimensional forms. Any of the systems described above can be used to perform these methods.

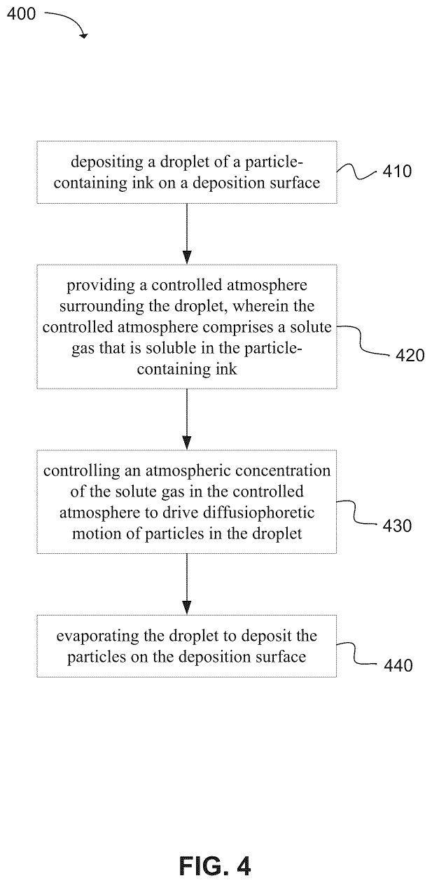

FIG. 4 is a flowchart illustrating one example diffusiophoresis-enhanced particle deposition method 400. This method includes: depositing a droplet of a particle-containing ink on a deposition surface 410; providing a controlled atmosphere surrounding the droplet, wherein the controlled atmosphere comprises a solute gas that is soluble in the particle-containing ink 420; controlling an atmospheric concentration of the solute gas in the controlled atmosphere to drive diffusiophoretic motion of particles in the droplet 430; and evaporating the droplet to deposit the particles on the deposition surface 440.

Although this flowchart specifies depositing a single droplet of the particle-containing ink on the deposition surface, in further examples the method can include depositing many droplets of the particle containing ink in any desired pattern on the deposition surface. The method can also be repeated to deposit multiple droplets in the same area of the deposition surface, which can build up multiple layers of deposited particles and create three-dimensional forms. In some examples, each individual droplet can be dried before depositing the next droplet. In other examples, multiple droplets of the ink can be deposited while previous droplets are still wet. The multiple droplets can dry over an evaporation time period. In certain examples, an entire layer of a three-dimensional object can be deposited as wet droplets and then the layer as a whole can be allowed to dry before then depositing droplets to form a second layer of the three-dimensional object. It is also noted that droplets of particulate-containing ink can be deposited in discrete droplets or if multiple droplets are deposited close enough together, the droplets may merge into a larger droplet. Either of these approaches can be used in the methods described herein.

In some examples, the evaporation time for a droplet of particle-containing ink can vary depending on the volatility of the particle-containing ink, the temperature of the deposition surface, the temperature of gas in the atmosphere control chamber, the flow rate of gas through the atmosphere control chamber, and other factors. In some examples, the particle-containing ink can be aqueous ink, and the evaporation rate can be affected by the amount of humidity in the atmosphere control chamber. In certain examples, the solute gas and diluent gas can pass through a desiccator before entering the atmosphere control chamber to ensure that humidity is as low as possible. When the particle-containing ink includes another solvent other than water, the solute gas and diluent gas can be free of the solvent when the gases are introduced into the atmosphere control chamber. This can ensure that the droplets evaporate as quickly as possible. Alternatively, the vapor concentration of the solvent can be controlled in the atmosphere control chamber if it is desired to control the evaporation rate. The evaporation rate can further be controlled by heating or cooling the deposition surface or the interior of the atmosphere control chamber.

In some examples, the time for evaporation of a droplet of particle-containing ink can be from about 0.1 second to about 1 hour, or from about 0.1 second to about 30 minutes, or from about 0.1 second to about 10 minutes, or from about 0.1 second to about 1 minute, or from about 0.1 second to about 30 seconds, or from about 0.1 second to about 1 second, or from about 1 second to about 1 hour, or from about 1 second to about 30 minutes, or from about 1 second to about 10 minutes, or from about 1 second to about 1 minute, or from about 1 second to about 30 seconds, or from about 30 seconds to about 1 hour, or from about 30 seconds to about 30 minutes, or from about 30 seconds to about 10 minutes, or from about 30 seconds to about 1 minute, or from about 1 minute to about 1 hour, or from about 1 minute to about 30 minutes, or from about 1 minute to about 10 minutes, or from about 10 minutes to about 1 hour, or from about 10 minutes to about 30 minutes, or from about 30 minutes to about 1 hour.

The diffusiophoresis-enhanced particle deposition methods can be performed using a computer or other electronic controller as described in the systems above. The controller can be used to control the flow of the solute gas and diluent gas, if used, into the atmosphere control chamber, thereby controlling the concentration of the solute gas in the atmosphere control chamber. In some examples, the method can also include measuring at least one condition in the atmosphere control chamber. This can be done using sensors, such as the sensors described above in the systems. After measuring at least one condition, the flow rate of solute gas and/or the diluent gas can be adjusted in response to a change in the at least one condition. The condition that is measured can include temperature, humidity, gas composition of the controlled atmosphere, or others.

### Examples

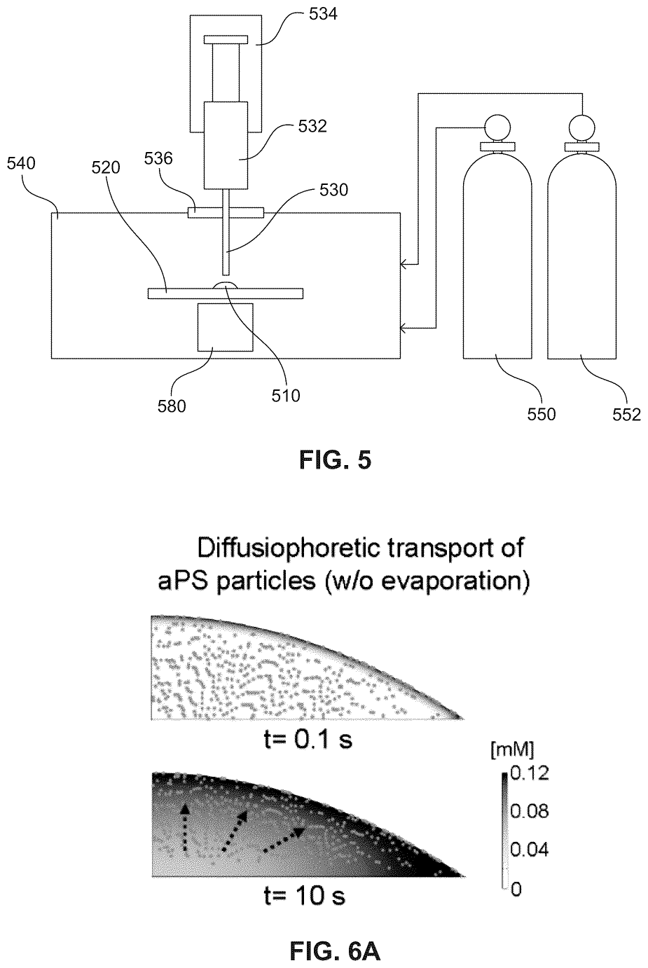

Computer models were used to simulate evaporation of sessile droplets of a particle-containing ink. Experiments were then performed with real droplets of a particle-containing ink, which were imaged to show the position of particles when the droplets evaporated. The simulations and experiments demonstrate the application of diffusiophoresis in an additive manufacturing (AM) system. The experiments utilized an example diffusiophoresis-enhanced microextrusion-based AM platform that leverages evaporation-driven nanoparticle printing inside a microenvironment. The example system was used to study the effect of non-contaminating solute gas on the deposition dynamics. A schematic of the system used in the experiments is shown in FIG. 5. This system included a droplet ejector 530, which is a syringe needle connected to a syringe reservoir 532 filled with particle-containing ink and a syringe pump 534 configured to eject controlled amounts of the ink through the needle. The deposition surface 520 was a glass slide. A camera 580 was positioned below the glass slide to capture images of the droplets 510 as they evaporated. The camera utilized fluorescence imaging to capture images of fluorescent particles in the ink. An atmosphere control chamber 540 surrounded the glass slide. The syringe needle entered the atmosphere control chamber through a septum 536. A carbon dioxide supply 550 was used as the solute gas supply, and a nitrogen supply 552 was used as the diluent gas supply.

Using this system, the concentration of soluble gases can be modulated in the microenvironment to generate diffusiophoretic forces in drying droplets, and the deposition dynamics and final printed patterns can be imaged and characterized. Significantly different particle deposition patterns were observed in N₂ and CO₂ environments, highlighting the significant role of diffusiophoresis on the dynamics. Simulations were also performed to gain insights into the effects of diffusiophoresis in the complex evaporation process. The diffusiophoretic transport of particles in non-evaporating and evaporating drops were simulated both with and without Marangoni effects. The significance of diffusiophoresis on the particle motions when exposed to CO₂ was demonstrated.

Materials used included the following: Fluorescent amine-functionalized polystyrene (aPS) latex particles (diameter=1 μm, Sigma Aldrich) were suspended at a concentration of 2.5 mg/ml in distilled water. The particle size distribution and zeta potential were measured by dynamic light scattering (Mobius, Wyatt Technologies).

A micro-syringe pump was used to control the printing flow rate of the ink. The platform included a four-axis micron-resolution motion control system (Aerotech, PA, USA) with translation and rotation capabilities for microscale precision in positioning and print speeds. The deposition surfaces used were 170±5 m-thick glass slides (Thorlabs, NJ, USA), and drops were printed with 25-gauge needles (GA). Substrates were cleaned using acetone and isopropyl alcohol and dried using compressed N₂ prior to printing.

Printed samples were imaged using inverted fluorescence microscopy (LEICA Microsystems, Germany) at 2.5× magnification with a monochrome FITC filter. Particles are visualized with green color using the LAS-X software to aid pattern visualization. Samples are imaged using two techniques. First, time-series images of the entire evaporation process were captured at constant exposure of 300 ms at 3-second intervals. Second, dried patterns were imaged at multiple exposures to obtain a higher dynamic range. Thus, small, delicate features can be obtained at higher exposures while preserving spatial data from thicker features obtained at lower exposures. The imaging platform automatically captures the above-mentioned image sets using a custom Python code.

The custom-built microenvironment chamber (atmosphere control chamber) was fabricated using a 3D printed design structure (Form 3B, Formlabs) with a 1.6 mm thick transparent acrylic bottom for imaging purposes. The top incorporates a septum, allowing the nozzle system to penetrate while minimizing gas leakage. Gas inlets and outlets were connected to valves to prevent leakage. The chamber was integrated with temperature and humidity sensors and a CO₂ sensor that were used to monitor the microenvironment. The gas introduced in the chamber was pumped through a desiccator unit to control the relative humidity inside the chamber.

The custom microenvironment-chamber integrated print platform can isolate the printing environment from the influence of ambient gases outside the chamber. This maintains a stable gas environment during the print and minimizes leakage of gases from the chamber. The primary control parameter for the experiments was to control the gaseous concentration in the chamber after filling it with CO₂ and N₂. The chamber's humidity, temperature, and gas composition were constantly monitored throughout printing. Minimal gas concentration variation was observed over the entire evaporation duration (˜30 minutes). The CO₂ concentration was consistently maintained at 0.0% for the control experiments using N₂. In the gaseous environment of CO₂, the CO₂ concentration saturated and maintained a stable reading at 73±2%. The relative humidity was maintained below 30% throughout the evaporation process.

Image analysis was used to calculate the change in the area of printed drops through the drying process. Initial state images were captured immediately after deposition, and final state images were captured after drying. All the droplets were imaged at 300 ms exposure to provide good contrast between the drop and background. Boundaries of the printed drops were identified using canny edge detection. A morphological closing process was then used to create contiguously linked edges. The drop area was then segmented using a morphological filling operation. All steps, from edge detection to morphological filling, were conducted on both the initial and final state images. Although simple pixel counting works to calculate the initial state area, calculating the final state area is non-trivial as dewetting effects frequently cause ink to separate into scattered depositions surrounding a substantially larger central deposition. Hence, basic pixel counting failed to analyze the spatial spread of the patterns and was not helpful for calculating drop shrinkage. To address that challenge, a convex hull was used to quantify the notional drop area for both states. However, due to the sensitivity of convex hulls to outliers, careful filtering of scattered satellite droplets was necessary prior to application. Thus, a filter that considers both particle size and spatial density was devised to determine which satellite drops belong to the core of the drop and which are outliers. First, satellite drops below 100 pixels in area were removed and considered insignificant. Next, core drops were defined as drops with centroids within 100 pixels of two other centroids. Outlier drops were those that did not meet this criterion. A region properties routine was utilized to calculate the centroids of each satellite drop and create a matrix of all drop centroid positions. Next, a nearest neighbor algorithm was utilized to calculate the two nearest neighbors of each drop. After this calculation, core and outlier drops were labeled, and a convex hull about only the core drops was computed. Finally, the initial state area and the final state convex hull area were computed to quantify the change in drop area throughout the drying process. Image processing was completed using functions from scikit-image, NumPy, OpenCV, and SciPy.

Simulations were performed with COMSOL Multi-physics 5.4a (COMSOL, Inc., USA). To simulate evaporation of a water droplet, a water droplet was modeled as an axisymmetric water droplet of 1 mm radius with a pinned contact line and initial contact angle of 38°. The substrate thickness was 0.1 mm. The drop radius was smaller than the capillary length l_{c}=\sqrt{σ/μg}=2.7×10⁻³ m for water, where a is the surface tension and g is the gravitational acceleration, so that gravity is neglected. The simulation solved coupled flow, heat transfer, and diffusion problems, and solved individual particle trajectories. The arbitrary Lagrangian-Eulerian (ALE) moving mesh was utilized to track the interface, and 3191 triangular elements were used for the droplet with a tolerance of 0.01.

Equations (1) through (6) above were used to model evaporation and diffusiophoretic mobilities. The fluid dynamics are governed by the continuity and Navier-Stokes equations:

$$∇ \cdot u = 0 , \qquad ( 7 )$$

$$ρ [ \frac{\partial u}{\partial t} + ( u \cdot ∇ ) u ] = - ∇ p + ∇ \cdot ( μ ∇ u ) , \qquad ( 8 )$$

where u is the velocity vector, and pp is the pressure. Heat transfer is governed by:

$$ρ {C}_{p} ( \frac{\partial T}{\partial t} + u \cdot ∇ T ) = ∇ \cdot ( k ∇ T ) , \qquad ( 9 )$$

where Cₚ is the heat capacity, and k is the thermal conductivity. Species transport in the drop is governed by:

$$\frac{\partial c}{\partial t} + u \cdot ∇ c = ∇ \cdot ( D ∇ c ) + R , \qquad ( 10 )$$

where c is the concentration, D is the diffusivity, and R is the reaction rate. Note, this form is used for evaporating drops such that convection is included (cf. Equations (4a) and (4b)). Particle trajectories are governed by

$$d ( {m}_{p} v ) / dt = {F}_{D}$$

where mₚ and v are the mass and velocity of the particle, respectively, and F_{D} is the drag force. Based on Stokes' law,

$${F}_{D} = 18 μ {m}_{p} ( {u}_{t} - v ) / {ρ}_{p} {d}_{p}^{2}$$

where ρₚ is the particle density (=1000 kg m⁻³), dₚ is the particle diameter (=1 μm), and uₜ is the sum of the fluid and diffusiophoretic velocities. Gravity, Brownian forces and particle-particle interactions are neglected.

For boundary conditions at the substrate (z=0), no-slip is applied for the fluid flow and no-flux conditions were applied for all species. A temperature of Tₛ=298 K was applied to the bottom of the substrate (z=−0.1 mm), and no-flux conditions were used for the remaining substrate surfaces. At the droplet surface, u·n=0, k∇T·n=−J(r)hₗ where hₗ is the latent heat of vaporization, and (n·τₗ)·t=dσ/dT (∇T·t) which drives Marangoni flows. Here, t is the unit tangent vector to the surface and τₗ is the viscous stress tensor. For concentrations, c=c_{i,s} and c=c_{c,s} for ion and CO₂, respectively. Equation (2) is used for the evaporative flux, and Equation (1) is used to impose the movement of the droplet surface. Here, Dᵥₐₚ=26×10⁶ m² s⁻¹ for the ambient air in N₂ and Dᵥₐₚ=15×10⁶ m² s⁻¹ in CO₂. For particles, bounce wall conditions were applied at the substrate and droplet interface (v=v_{c}−2(n·v_{c})n, where v_{c} is the particle velocity when striking the boundary).

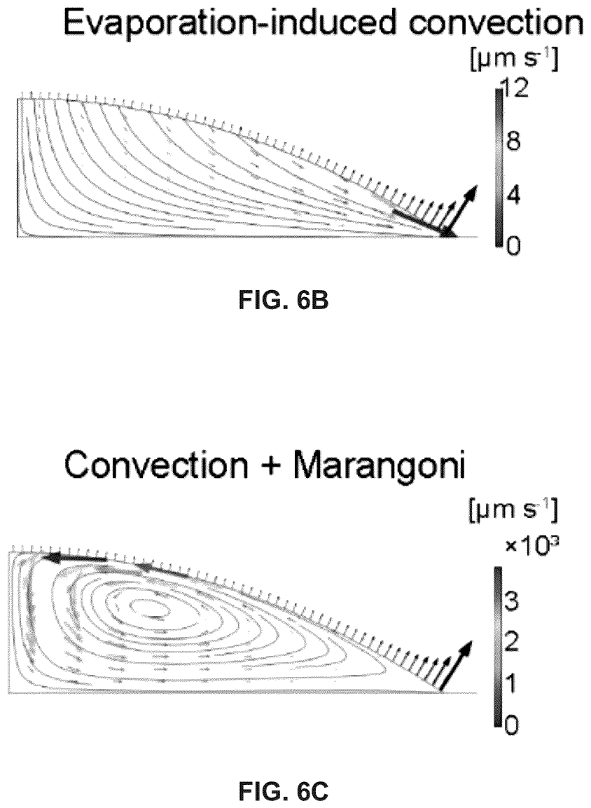

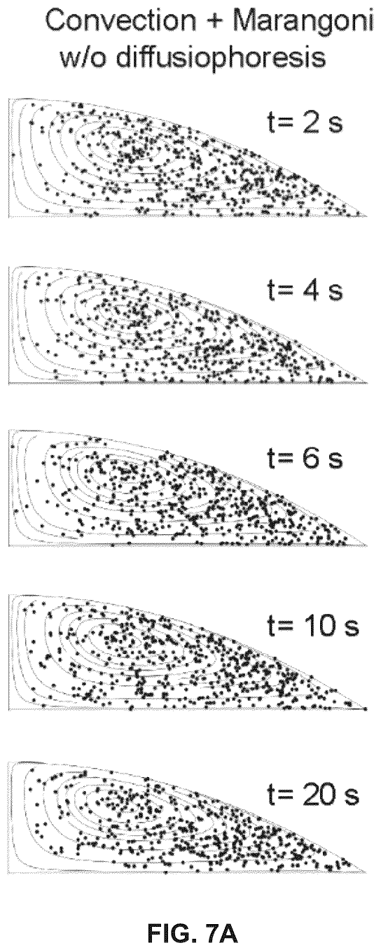

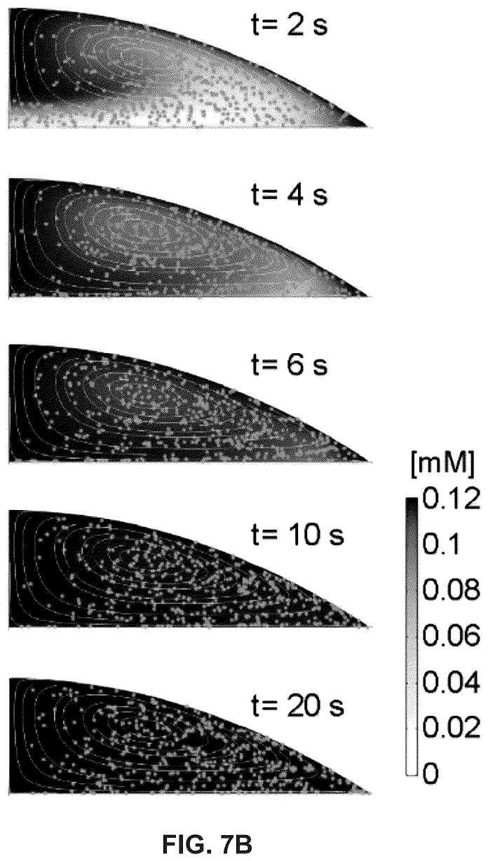

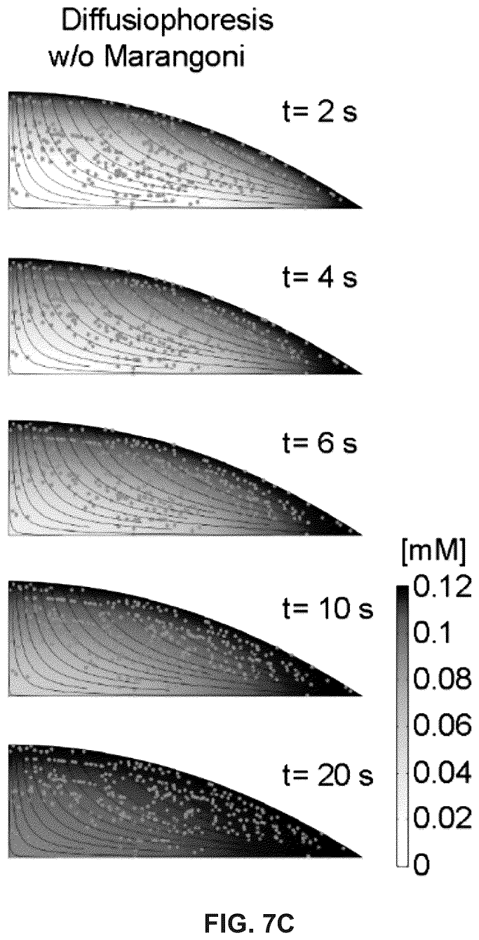

As a proof-of-concept, a first simulation was performed simulating the motion of positively charged aPS particles (ζ≈31 mV) in a stationary, non-evaporating drop. FIG. 6A shows the resulting ion gradient in the drop and the associated particle migration toward the drop interface at time t=0.1 s and t=10 s. FIG. 6B shows the typical flow profile in an evaporating drop at 30% relative humidity at t=10 s. The primary flow is toward the droplet edge where the evaporation flux is highest. FIG. 6C shows the flow profile including Marangoni effects, where the surface tension gradients drive rotating internal flow. Velocities associated with Marangoni flows (O(0)−O(1) mm s⁻¹) are faster than those for pure evaporation (O(0)−O(10) μm s⁻¹). Particle dynamics are calculated for various conditions in FIGS. 7A-7C. FIG. 7A shows the particle dynamics in an evaporating drop in air with Marangoni effects. Here, particles are convecting along the rotating Marangoni flows and are prevented from accumulating at the contact line over this time scale. FIG. 7B shows the results for evaporation in CO₂, including the diffusiophoresis. As can be seen, the Marangoni flow drives a swirling behavior of the dissolved ion concentration, which complicates the role of diffusiophoresis, as the particles move toward high concentration. In these conditions, the Marangoni flow tends to dominate the effects of diffusiophoresis, except near the substrate, where the fluid velocity is necessarily low, which allows diffusiophoresis to still drive particles along the substrate toward the contact line. However, the strong mixing via Marangoni flows leads to nearly saturated ion concentrations within 10 s, such that diffusiophoretic effects are not long-lived. Finally, FIG. 7C shows the particle dynamics in CO₂ without Marangoni effects, in which diffusiophoresis is able to drive significant particle motion toward the interface, and the ion gradients can persist for a significantly longer timescale.

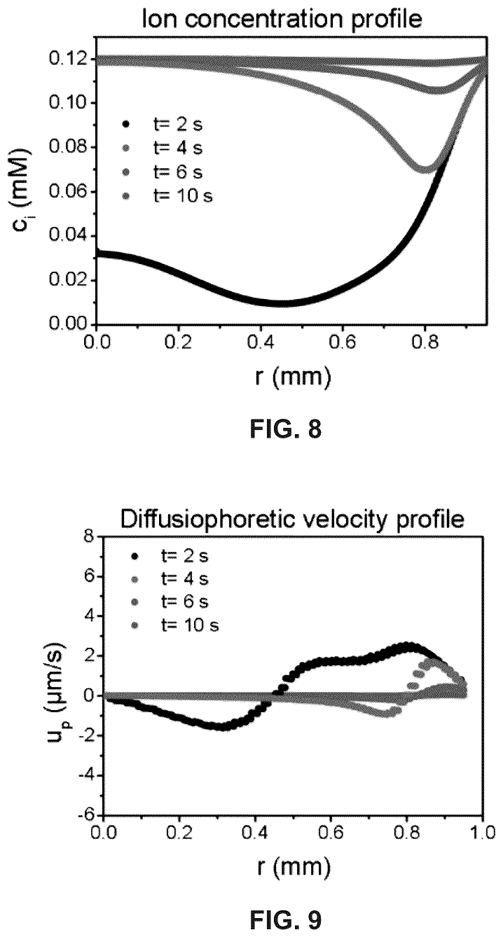

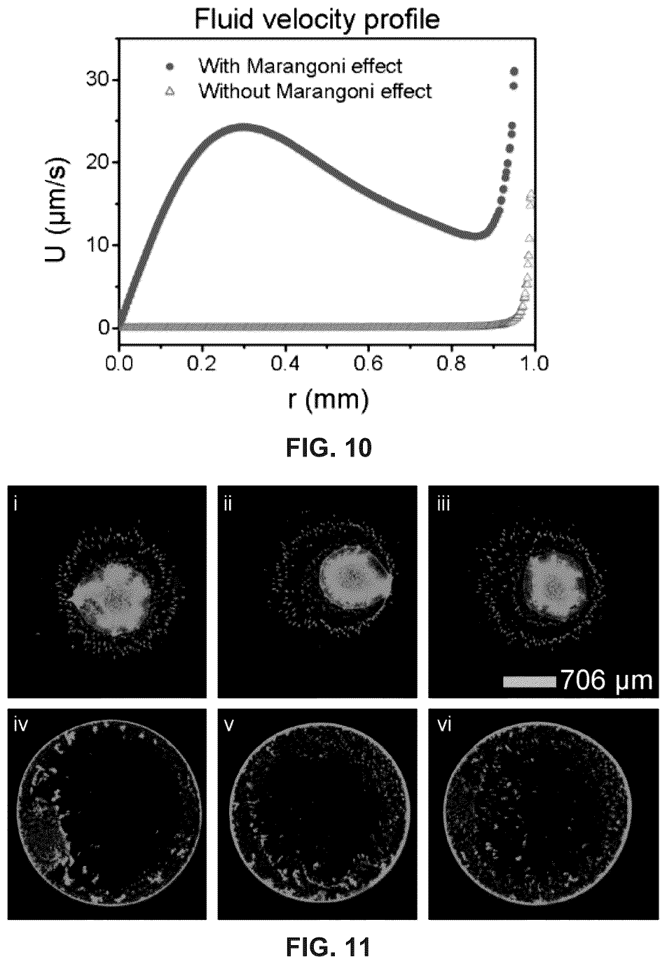

FIG. 8 shows the evolution of the ion concentration profile along the r-direction at t=2,4,6 and 10 s in an evaporating droplet in CO₂ at a height of 2 μm from the substrate surface. At early times, the high ion concentration region is confined near the interface, where it is pulled radially inward along the interface by the Marangoni flows, leading to relatively fast saturation near the center. The ion concentration appears to fully saturate in around 10 s. FIG. 9 shows the diffusiophoretic velocity of the aPS particles in the r-direction based on the calculated concentration profiles of FIG. 8 with the diffusiophoretic mobility of 0.3×10⁻⁹ m⁻² s⁻¹. Since aPS particles are driven toward higher concentrations by diffusiophoresis, their migration direction changes at r≈0.45 mm at t=2 s, again due to the recirculating Marangoni flow. Here, the maximum velocity of the particles is about 2.5 μm s⁻¹ at r≈0.8. At t=2 s, the diffusiophoretic particle transport is driven toward the contact line at r>˜0.8 mm as the radial position with the lowest concentration value moves, where the maximum velocity is ˜1.7 μm s⁻¹. The diffusiophoresis decays over approximately 10 s due to the concentration saturation. FIG. 10 shows the relative fluid velocity magnitudes both with and without Marangoni effects in CO₂ at a height of 2 μm from the substrate. Magnitudes with Marangoni effects are significantly stronger, but both diverge near the contact line due to the diverging evaporative flux. These results indicate that diffusiophoresis is relatively weak compared to the fluid flow including Marangoni effects, although diffusiophoresis can dominate the fluid flow without Marangoni effects over the early time regime. Nevertheless, the experiments will show a significant difference in the particle depositions with and without diffusiophoresis. This is likely due to the fact that diffusiophoresis can still dominate the Marangoni flows near the substrate because of no-slip, which allows particle motion toward the contact line near the substrate and can also alter the pinning dynamics of the contact line.

As proof-of-concept, experiments were performed with the evaporation-driven assembly in both N₂ and CO₂ environments. FIG. 11 shows the results for the final dried patterns in both conditions, with droplets (i), (ii), and (iii) deposited in a nitrogen atmosphere and droplets (iv), (v), and (vi) deposited in a carbon dioxide atmosphere. In N₂, the drops evaporate in ambient conditions without diffusiophoresis. Here, a complex interplay of forces, such as capillary and Marangoni flow effects, guide the evaporation. The droplets in FIG. 11 identified as (i), (ii), and (iii) show the formation of a clustered deposit with scattered dewetting patterns around it. This suggests that the pinning force is insufficient to pin the droplet, and dewetting occurs. As the droplet continuously depins, leaving scattered deposits, the droplet volume decreases and ultimately deposits as a clustered feature. These patterns are guided by the print parameters such as particle concentration and substrate, and the N₂ does not play a role. N₂ is inert and does not dissociate to form ions in aqueous solvents. These experiments serve as controls for comparison with droplets printed in other environments. Droplets (iv), (v), and (vi) were printed in a CO₂ environment, exhibiting a relatively uniform internal texture with a strong peripheral coffee ring. This pattern variation is attributed to the introduction of diffusiophoresis. The CO₂ produces non-interfering solute ions in the drop yielding transient concentration gradients that drive particle diffusiophoresis. In this case, the diffusiophoresis alters the particle dynamics near the substrate and contact line in such a manner as to increase the pinning forces enough to fix the contact line and produce a relatively uniform internal texture.

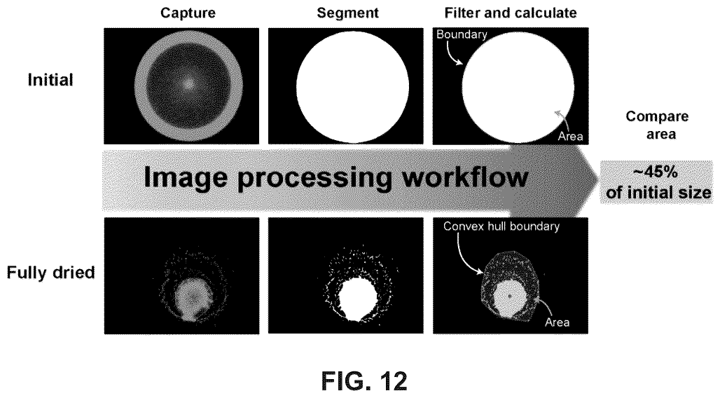

Quantitative comparisons of the observed patterns were performed leveraging image-processing techniques. Significant real-time variation in pattern and size were observed for droplets dried under CO₂ and N₂. Variations in size were characterized by measuring the segmented area of the patterns to quantify the degree of shrinkage. FIG. 12 shows the image processing workflow, which involves segmenting the printed samples. The calculation of the drop area was trivial for the initial state as all ink remained coalesced into a single drop. Thus, simple pixel counting of the initial state segmentation was sufficient. However, a similar pixel-counting approach for the final state area failed to provide an idea of the spatial spread of the pattern. To address this, the convex hull approach was implemented. This approach successfully captured the scattered drops to estimate the dried area, and the initial and final areas were then compared to quantify the degree of shrinkage.

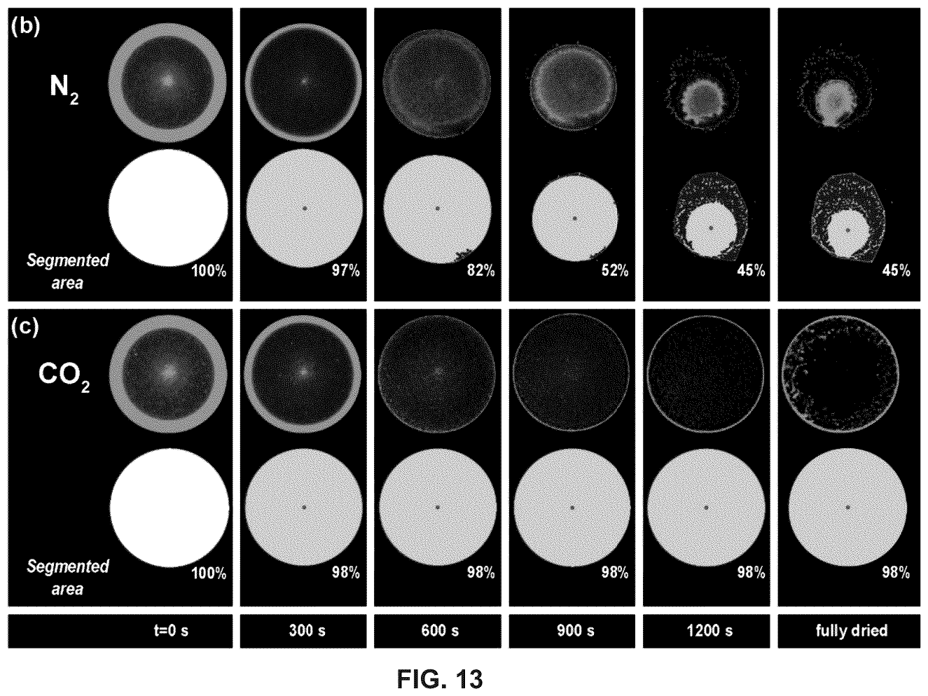

Real-time images of the deposition processes in N₂ and CO₂ are shown in FIG. 13 at 0 s, 300 s, 600 s, 900 s, 1200 s, and at complete evaporation. At 300 s, particles exhibit stronger motion toward the contact line in CO₂, attributing to the thicker ring-like pattern. At 600 s, the contact line has begun slipping in N₂, unlike the pattern in CO₂, where the pinning is strong, and the particles begin to deposit a ring-like pattern. This is illustrated by the segmented area in N₂, which has reduced to 82% of its initial size. This continues as the droplet dries, and at 1200 s, scattered dewetting drops become prominent in N₂, with the area decreasing to 45%, while the deposited ring thickness gradually increases in CO₂. The droplet area in N₂ ultimately shrinks to roughly 50±2% of the initial size for all the sample prints. The deposition patterns in CO₂ demonstrate relatively constant areas throughout the evaporation with variations of only about ±1%. The convex hull approach is susceptible to overestimating the non-convex shapes, such as the scattered droplets. Hence it is not entirely accurate in calculating drop area and introduces a certain degree of variation in the measurements. Such variations in area measurements can be further improved by tweaking the filtering process to detect lower-intensity scattered deposits of significant size.

The experimental results indicate that diffusiophoresis can alter the evaporation dynamics and provide a mechanism for controlling particle deposition and pattern formation in drying drops simply by modulating the microenvironment. The simulations described above of the particle dynamics were performed in a variety of scenarios including with and without evaporation, with and without Marangoni effects, and with and without diffusiophoresis. Results show that the Marangoni effects typically dominate the particle motion, but diffusiophoresis may play a role near the substrate and near the contact line. Next, the customized microenvironment chamber for micro-extrusion printing with in-situ fluorescence imaging was used to observe the drying dynamics and pattern formation for evaporating drops in N₂ and CO₂ environments. Image analysis was performed to quantify the area shrinkage of the printed patterns for both cases. These results address scientific gaps on whether gas-based, non-contaminating solutes can generate sufficient forces to affect the pattern formation process in the evaporative assembly of nanoparticles.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A diffusiophoresis-enhanced particle deposition system, comprising:
a deposition surface;
a droplet ejector connectable to a supply of particle-containing ink, the droplet ejector positioned to eject droplets of the particle-containing ink onto the deposition surface;
an atmosphere control chamber surrounding the deposition surface; and
a supply of a solute gas that is soluble in the particle-containing ink connected to the atmosphere control chamber to provide a controlled atmospheric concentration of the solute gas to droplets on the deposition surface.

2. The system of claim 1, wherein the particle-containing ink contains particles that comprise polymer microparticles, polymer nanoparticles, quantum dots, cells, metal microparticles, or a combination thereof.

3. The system of claim 1, wherein the particle-containing ink contains particles in a concentration from about 0.1 mg/mL to about 10 mg/mL.

4. The system of claim 1, wherein the particle-containing ink comprises a solvent selected from the group consisting of water, ethanol, polar hydrocarbon solvents, acetone, methyl ethyl ketone, and combinations thereof.

5. The system of claim 1, wherein the solute gas comprises carbon dioxide, ammonia, or a combination thereof.

6. The system of claim 1, wherein the droplet ejector comprises a micro-syringe pump.

7. The system of claim 1, further comprising a motion platform operable to move the droplet ejector with respect to the deposition surface on at least one axis.

8. The system of claim 1, wherein the atmosphere control chamber encloses the deposition surface and a print volume.

9. The system of claim 1, wherein the atmosphere control chamber comprises a septum and wherein the droplet ejector comprises a needle operable to pierce the septum to eject the droplets onto the deposition surface.

10. The system of claim 1, wherein the deposition surface and droplet ejector are inside the atmosphere control chamber.

11. The system of claim 1, further comprising a supply of a diluent gas connected to the atmosphere control chamber to allow control of fractions of the diluent gas and the solute gas in the atmosphere control chamber.

12. The system of claim 1, further comprising a controller operatively connected to the supply of solute gas to control a flow of the solute gas to the atmosphere control chamber, wherein the controller is programmed with coded instructions to adjust the flow of the solute gas to provide the controlled atmospheric concentration of the solute gas to the droplets on the deposition surface.

13. The system of claim 12, further comprising at least one sensor configured to measure at least one condition in the atmosphere control chamber, wherein the sensor is in communication with the controller, and wherein the coded instructions include adjusting the flow of the solute gas in response to a change in the at least one condition.

14. The system of claim 13, wherein the at least one sensor comprises a gas composition sensor, gas concentration sensor, a pressure sensor, a temperature sensor, a humidity sensor, or a combination thereof.

15. A diffusiophoresis-enhanced particle deposition method, comprising:
depositing a droplet of a particle-containing ink on a deposition surface;
providing a controlled atmosphere surrounding the droplet, wherein the controlled atmosphere comprises a solute gas that is soluble in the particle-containing ink;
controlling an atmospheric concentration of the solute gas in the controlled atmosphere to drive diffusiophoretic motion of particles in the droplet; and
evaporating the droplet to deposit the particles on the deposition surface.

16. The method of claim 15, wherein the droplet is deposited using a micro-syringe pump.

17. The method of claim 15, further comprising depositing a plurality of additional droplets on the deposition surface at different positions on at least one axis.

18. The method of claim 15, wherein the controlled atmosphere is in an atmosphere control chamber.

19. The method of claim 15, wherein providing the controlled atmosphere comprises flowing a diluent gas and the solute gas and wherein controlling the atmospheric concentration of the solute gas comprises adjusting relative flow rates of the diluent gas and the solute gas.

20. The method of claim 15, further comprising measuring at least one condition in the atmosphere control chamber and adjusting the flow of the solute gas in response to a change in the at least one condition.

21. The method of claim 20, wherein the at least one condition comprises gas composition in the controlled atmosphere, temperature, humidity, gas pressure or a combination thereof.
